(19) United States
(12) Patent Application Publication
(10) Pub. No.: US 2011/0191514 A1
(43) Pub. Date: Aug. 4, 2011

(54) SERVER SYSTEM

(75) Inventors: Jian-Feng Wu, Shanghai (CN); Tsai-Kuei Cheng, Taipei City (TW)

(73) Assignee: INVENTEC CORPORATION, TAIPEI CITY (TW)

(21) Appl. No.: 12/696,058

(22) Filed: Jan. 29, 2010

(51) Int. Cl. G06F 13/00; G06F 1/26

(52) U.S. Cl. 710/301; 713/300

(57) ABSTRACT

A server system includes a management board having a baseboard management controller provided thereon; a plurality of middle boards separately connected to the management board; a plurality of mainboards separately connected to the middle boards; and a hard disk (HD) module connected to the middle boards. Each of the middle boards has a plurality of mainboard connection ports and at least one HD signal connection port. The mainboards are separately connected to the mainboard connection ports, and the baseboard management controller manages the mainboards via the middle boards. The HD module has an HD backplane being connected to the HD signal connection ports, and the mainboards are connected to the HD module via respective correspondingly connected middle board.

### FIELD OF THE INVENTION

The present invention relates to an electronic apparatus, and more particularly to a server system.

### BACKGROUND OF THE INVENTION

Following the progress in different technological fields and the increasing dependence of people on computer systems, consumers have higher and higher demands for the increased computing ability and data storage capacity of computer systems. To effectively provide users with required data and data storage, a computer system must have many hard disks and other storage media to provide good data access service. In a computer case, there are installed mainboards, storage media, and many other built-in peripherals, so as to efficiently provide various user-demanded services. Taking a server as an example, the server has a chassis that usually has only very limited internal space and it is therefore a very important task to efficiently arrange and assemble all necessary components and parts in the chassis.

Further, the mainboards of a server are usually provided with a baseboard management controller (BMC) each. The functions provided by the baseboard management controller include: monitoring the working state of the correspondingly connected mainboard thereof, controlling fans in the chassis to operate; linking to Internet via the IPMI (Intelligent Platform Management Interface) platform; and allowing a remote operator to monitor and operate a server from a remote location, such as powering on the server or obtaining the working state of mainboards of the server from a remote location. Generally, each individual mainboard has an independent baseboard management controller. However, for the currently available server that has many mainboards mounted in the chassis thereof, it would require an integrated management of these mainboards and the baseboard management controllers thereof. That is, it would be necessary to further provide a chip in the server for integrated and centralized management of the components and parts of the server. However, either the baseboard management controllers or the chip for integrated and centralized management requires relatively high cost.

### SUMMARY OF THE INVENTION

It is therefore a primary object of the present invention to provide a server system so as to reduce the cost needed to provide a chip in a server and enable easy and smooth assembling of the server.

To achieve the above and other objects, the server system according to an embodiment of the present invention includes a management board having a baseboard management controller provided thereon; a plurality of middle boards separately connected to the management board; a plurality of mainboards separately connected to the middle boards; a hard disk (HD) module connected to the middle boards; and a plurality of power supply modules. Each of the middle boards has a plurality of mainboard connection ports and at least one HD signal connection port. The mainboards are separately connected to the mainboard connection ports, and the baseboard management controller manages the mainboards via the middle boards. The HD module includes an HD backplane and a plurality of hard disks connected to the HD backplane. The HD backplane is connected to the HD signal connection port, and the mainboards are connected to the hard disks of the HD module via respective correspondingly connected middle board. The power supply modules each include a power distribution board, on which a first, a second and a third power connection port are provided. The first power connection ports are separately connected to the middle boards for supplying power to the mainboards via the middle boards; the second power connection ports are connected to the management board for supplying power thereto; and the third power connection ports are connected to the HD backplane for supplying power to the HD module. The power supply modules each further include a power control signal connection port connected to the management board.

The management board is further provided with a plurality of fan connection ports, to which a plurality of fans is separately connected. The baseboard management controller controls the fans via the fan connection ports according to working states of the mainboards. The server system further includes a plurality of ON/OFF circuit boards connected to the management board and in one-to-one correspondence to the middle boards. Each of he ON/OFF circuit boards including a plurality of ON/OFF buttons, and the ON/OFF buttons on one ON/OFF circuit board are in one-to-one correspondence to the mainboards that are connected to the middle board corresponding to that ON/OFF circuit board.

The server system further includes a chassis having a bottom plate and an internal partition plate, the partition plate is provided with at least one conductor hole and is vertically erected on the bottom plate to divide the chassis into a front space and a rear space. The management board and the HD module are arranged in the front space. The rear space is further divided into an upper rear space and a lower rear space, both being parallel to the bottom plate. The upper rear space and the lower rear space respectively has one of the middle boards, two of the mainboards, and one of the power supply modules arranged therein. In each of the front and lower rear spaces, the middle board has a front side closer to the partition plate and the mainboards and the power supply module are connected to a rear side of the middle board. The mainboards are separately located near left and right ends of the middle boards, and the power supply modules are located between the left and the right mainboards.

The server system further includes a plurality of fans arranged in the front space to locate near left and right ends of the partition plate and connected to the management board. The management board controls the left fans to cool the left mainboards in the upper rear space and the lower rear space, and controls the right fans to cool the right mainboards in the upper rear space and the lower rear space.

The middle boards are parallel to the bottom plate, the mainboard connection ports each are a golden finger structure, and the mainboards are parallel to the bottom plate and slidably installed in the chassis to connect to the golden finger structures. The management board is fixedly mounted on the bottom plate near the at least one conductor hole on the partition plate. The management board is electrically connected to the middle boards and the power distribution boards via conductors that are separately extended through the at least one conductor hole. The HD module is located in front of the management board and the HD backplane is vertically erected on the bottom plate. The HD backplane is connected to the HD signal connection ports and the third power connection ports via conductors, which are extended through the at least one conductor hole. In this case, the server system further includes a plurality of ON/OFF circuit boards electrically connected to the management board and in one-to-one correspondence to the middle boards and the ON/OFF circuit boards are provided to two lateral sides of the front space of the chassis.

According to the present invention, via the middle boards, the baseboard management controller on the management board is able to manage all the mainboards electrically connected thereto. Thus, it is not necessary to provide one baseboard, management controller for each individual mainboards and the manufacturing cost of the server system can be effectively reduced, accordingly. Moreover, the middle boards not only serve to relay signals, but also connect to the power supply modules to enable power supply to the mainboards via the middle boards.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a server system according to an embodiment of the present invention;

FIG. 2 is a top view of the server system according to an embodiment of the present invention; and

FIG. 3 is a cutaway view of FIG. 2.

### DETAILED DESCRIPTION OF THE PREFERRED EMBODIMENTS

The present invention will now be described in more details with some embodiments thereof with reference to the accompanying drawings. One having ordinary skill in the art to which the present invention pertains would be able to make changes and modifications to the present invention based on the technical means taught in the illustrated embodiments of the present invention without departing from the spirit and scope of the present invention.

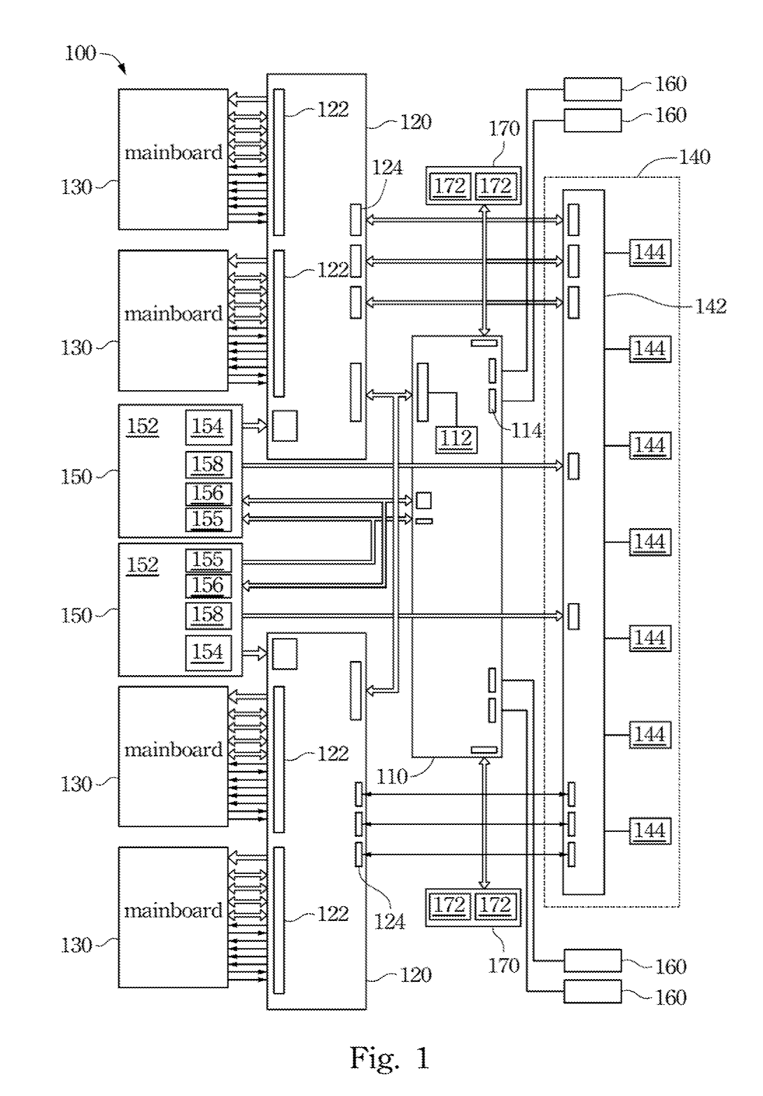

Please refer to FIG. 1 that is a block diagram of a server system 100 according to an embodiment of the present invention. As shown, the server system 100 includes a management board 110, a plurality of middle boards 120, a plurality of mainboards 130, a hard disk (HD) module 140, and a plurality of power supply modules 150. On the management board 110, there is provided a baseboard management controller (BMC) 112. The middle boards 120 are separately connected to the management board 110, and each of the middle boards 120 has a plurality of mainboard connection ports 122 and at least one HD signal connection port 124 provided thereon. The mainboards 130 are separately connected to the mainboard connection ports 122 on the middle boards 120. In the illustrated embodiment, each of the middle boards 120 has two corresponding mainboards 130 connected thereto. The baseboard management controller 112 on the management board 110 manages the mainboards 130 via the middle boards 120.

The HD module 140 includes a HD backplane 142 and a plurality of hard disks 144. The hard disks 144 are connected to the HD backplane 142 that is then further connected to the HD signal connection ports 124 on the middle boards 120, so that each of the mainboards 130 is electrically connected via the correspondingly connected middle board 120 thereof to the hard disks 144.

Each of the power supply modules 150 has a power distribution board 152, and each of the power distribution boards 152 has a first, a second and a third power connection port 154, 156, 158 provided thereon. Each of the power supply modules 150 is connected via the first power connection port 154 thereof to a corresponding one of the middle boards 120, so as to supply power to the mainboards 130 correspondingly connected to that middle board 120. The second power connection ports 156 are connected to the management board 110 for supplying power thereto. The third power connection ports 158 are connected to the HD backplane 142 for supplying power to the HD module 140.

Each of the power distribution boards 152 further has a power supply control signal connection port 155 provided thereon for connecting to the management board 110. The management board 110 is provided with a plurality of fan connection ports 114, to which a plurality of fans 160 are separately connected. The baseboard management controller 112 on the management board 110 obtains a working state of each of the mainboards 130 via the middle boards 120, and controls the fans 160 via corresponding fan connection ports 114 according to the working state of the mainboards 130.

The server system 100 further includes a plurality of ON/OFF circuit boards 170, which are in a number the same as that of the middle boards 120 and are connected to the management board 110 and in one-to-one correspondence to the middle boards 120. The ON/OFF circuit boards 170 each have a plurality of ON/OFF buttons 172 provided thereon, such that the ON/OFF buttons 172 on each of the ON/OFF boards 170 are in one-to-one correspondence to the mainboards 130 that are connected to the middle board 120 corresponding to that ON/OFF board 170. That is, every ON/OFF button 172 turns on or off a corresponding mainboard 130 thereof.

In the above description, only the connection ports on one side are described. However, in practical use, connection ports are provided in pair on two objects that are to be connected to each other. For example, each of the mainboards 130 is also provided with another mainboard connection port corresponding to the mainboard connection port 122 provided on its corresponding middle board 120, so that the middle board 120 is connected to the mainboard 130 via the two paired mainboard connection ports 122.

In the server system of the present invention, only one baseboard management controller is used to correspond to a plurality of mainboards to thereby largely reduce the number of the baseboard management controllers to be provided in a server system, while the one single baseboard management controller can still achieve the function of monitoring a plurality of mainboards to ensure the normal operation among different components and parts of the whole server system.

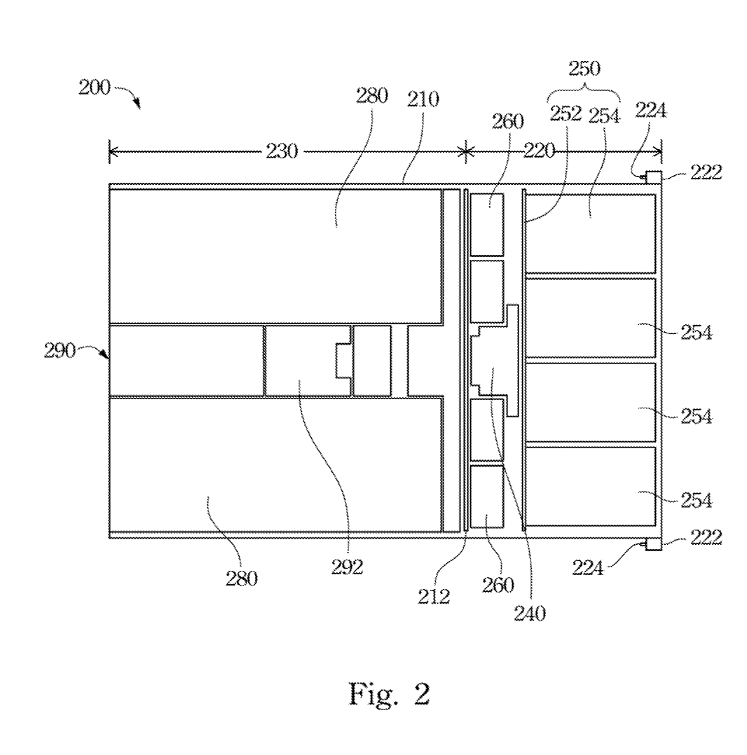

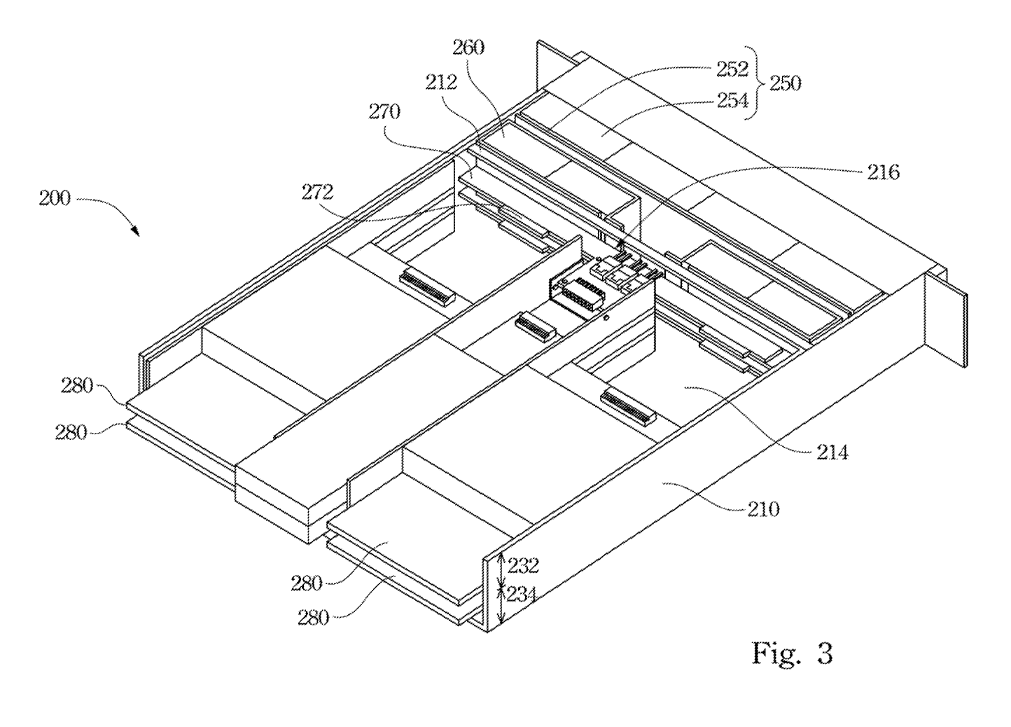

FIG. 2 is a top view of a server system 200 according to an embodiment of the present invention, and FIG. 3 is a cutaway view of a chassis of the server system of FIG. 2. Please refer to FIGS. 2 and 3 at the same time. As shown, the server system 200 of the present invention includes a chassis 210, which has an internal partition plate 212 and a bottom plate 214. The partition plate 212 is vertically erected on the bottom plate 214 of the chassis 210 to divide an internal space of the chassis 210 into a front space 220 and a rear space 230. A management board 240, an HD module 250, and a plurality of fans 260 are installed in the front space 220 of the chassis 210, while a plurality of middle boards 270, a plurality of mainboards 280, and a plurality of power supply modules 290 are installed in the rear space 230 of the chassis 210.

The fans 260 are arranged adjacent to the partition plate 212 to locate near left and right ends of the partition plate 212 and are connected to the management board 240, which is fixedly mounted to the bottom plate 214 of the chassis 210 and located between the left and the right fans 260. The partition plate 212 is provided with a plurality of conductor holes 216, via which conductors from the management board 240 are extended to connect to the middle boards 270 and a power distribution board 292 of each of the power supply modules 290.

The HD module 250 is arranged in front of the management board 240, and includes an HD backplane 252 vertically erected on the bottom plate 214 as well as a plurality of hard disks 254 connected to the HD backplane 252. The HD backplane 252 is electrically connected via conductors, which are extended through the conductor holes 216 on the partition plate 212, to HD signal connection ports provided on the middle boards 270 and to third power connection ports provided on the power distribution boards 292.

The rear space 230 is further divided into an upper rear space 232 and a lower rear space 234. The upper rear space 232 and lower rear space 234 are in parallel to the bottom plate 214 with the lower rear space 234 closer to the bottom plate 214 and the upper rear space 232 farther from the bottom plate 214.

The upper rear space 232 and the lower rear space 234 each have one middle board 270, two mainboards 280, and one power supply module 290 located therein. The middle boards 270 each have a front side closer to the partition plate 212, while the mainboards 280 and the power supply modules 290 are connected to a rear side of the middle boards 270. Conductors from the management board 240 are extended through the conductor holes 216 on the partition plate 212 to connect to the middle boards 270. The mainboards 280 are separately arranged near left and right ends of the partition plate 212 with the power supply modules 290 located between the left and the right mainboards 280. The management board 240 controls the left fans 260 to cool the left mainboards 280 in the upper rear space 232 and the lower rear space 234, and controls the right fans 260 to cool the right mainboards 280 in the upper rear space 232 and the lower rear space 234.

The middle boards 270 and the mainboards 280 are so installed that they are parallel to the bottom plate 214. It is noted mainboard connection ports 272 on the middle boards 270 for connecting the mainboards 280 to the middle boards 270 are of a golden finger structure, and the mainboards 280 are slidably installed in the chassis 210 and connected to the mainboard connection ports 272, which are of the golden finger structure.

The server system 200 further includes two ON/OFF circuit boards 222, which are separately arranged at two lateral sides of the front space 220 of the chassis 210 to connect to the management board 240 and are in one-to-one correspondence to the middle boards 270. The ON/OFF circuit boards 222 each have a plurality of ON/OFF buttons 224, and the ON/OFF buttons 224 on one ON/OFF circuit board 222 respectively control one of the mainboards 280 that are connected to the middle board 270 which is in one-to-one correspondence to that ON/OFF circuit board 222.

It can be seen from the above described preferred embodiments that the present invention has the following advantages: (1) via the middle boards, the baseboard management controller on the management board is able to manage all the mainboards electrically connected thereto, so that it is not necessary to provide one baseboard management controller for each individual mainboard and the manufacturing cost of the server system can be effectively reduced; (2) the middle boards not only serve to relay signals, but also connect to the power supply modules for the latter to supply power to the mainboards via the middle boards; and (3) the components and parts for the server system are arranged in the chassis in a reasonable manner to effectively reduce the cost for assembling the server system.

The present invention has been described with some preferred embodiments thereof and it is understood that these embodiments are not intended to restrict the present invention in any way and that many changes and modifications in the described embodiments can be carried out without departing from the scope and the spirit of the invention that is intended to be limited only by the appended claims.

What is claimed is:

1. A server system, comprising:
a management board having a baseboard management controller provided thereon;
a plurality of middle hoards being separately connected to the management board, and each of the middle boards having a plurality of mainboard connection ports and at least one HD signal connection port provided thereon;
a plurality of mainboards being separately connected to the mainboard connection ports on the middle boards, and the baseboard management controller managing the mainboards via the middle boards;
an HD module having an HD backplane connected to the HD signal connection ports on the middle boards and a plurality of hard disks connected to the HD backplane; and the mainboards being electrically connected to the hard disks via respective correspondingly connected middle board; and
a plurality of power supply modules respectively having a power distribution board; on each of the power distribution boards, there being provided a first, a second and a third power connection port; the first power connection ports being separately connected to the middle boards, so as to supply power to the mainboards via the middle boards; the second power connection ports being connected to the management board for supplying power thereto; the third power connection ports being connected to the HD backplane for supplying power to the HD module.

2. The server system as claimed in claim 1, wherein each of the power distribution boards further has a power supply control signal connection port provided thereon; and the power supply control signal connection ports being connected to the management board.

3. The server system as claimed in claim 1, wherein the management board is further provided thereon with a plurality of fan connection ports, to which a plurality of fans are separately connected; and the baseboard management controller controlling the fans via the fan connection ports according to working states of the mainboards.

4. The server system as claimed in claim 1, further comprising a plurality of ON/OFF circuit boards being connected to the management board and being in one-to-one correspondence to the middle boards.

5. The server system as claimed in claim 4, wherein each of the ON/OFF circuit boards includes a plurality of ON/OFF buttons, and the ON/OFF buttons on one ON/OFF circuit board being in one-to-one correspondence to the mainboards that are connected to the middle board in one-to-one correspondence to that ON/OFF circuit board.

6. The server system as claimed in claim 1, further comprising a chassis having a bottom plate and an internal partition plate; the partition plate being provided with at least one conductor hole and being vertically erected on the bottom plate to divide an internal space of the chassis into a front space and a rear space; the management board and the HD module being arranged in the front space; the rear space being further divided into an upper rear space and a lower rear space, both being parallel to the bottom plate; the upper rear space and the lower rear space respectively having one of the middle boards, two of the mainboards, and one of the power supply modules arranged therein; and wherein, in each of the front and lower rear spaces, the middle board has a front side closer to the partition plate and the mainboards and the power supply module are connected to a rear side of the middle board.

7. The server system as claimed in claim 6, wherein the mainboards are separately located near left and right ends of the middle boards, and the power supply modules are located between the left and the right mainboards.

8. The server system as claimed in claim 7, further comprising a plurality of fans arranged in the front space to locate near left and right ends of the partition plate and connected to the management board; the management board controlling the left fans to cool the left mainboards in the upper rear space and the lower rear space, and controlling the right fans to cool the right mainboards in the upper rear space and the lower rear space.

9. The server system as claimed in claim 6, wherein the middle boards are parallel to the bottom plate, the mainboard connection ports each are a golden finger structure, and the mainboards are parallel to the bottom plate and slidably installed in the chassis to connect to the golden finger structures.

10. The server system as claimed in claim 6, wherein the management board is fixedly mounted on the bottom plate near the at least one conductor hole on the partition plate; and the management board being electrically connected to the middle boards and the power distribution boards via conductors that are separately extended through the at least one conductor hole.

11. The server system as claimed in claim 10, wherein the HD module is located in front of the management board and the HD backplane is vertically erected on the bottom plate, and the HD backplane being connected to the HD signal connection ports and the third power connection ports via conductors, which are extended through the at least one conductor hole.

12. The server system as claimed in claim 6, further comprising a plurality of ON/OFF circuit boards electrically connected to the management board and in one-to-one correspondence to the middle boards, and the ON/OFF circuit boards being provided on two lateral sides of the front space of the chassis.
